(19) United States
(12) Patent Application Publication
(10) Pub. No.: US 2026/0267391 A1
(43) Pub. Date: Sep. 10, 2026

(54) SOC POWER AND PERFORMANCE CONTROL SYSTEM

(71) Applicant: Microsoft Technology Licensing, LLC, Redmond, WA (US)

(72) Inventors: Donghwi KIM, Kirkland, WA (US); Gregory Allen NIELSEN, Kirkland, WA (US)

(21) Appl. No.: 19/069,829

(22) Filed: Mar. 4, 2025

(51) Int. Cl. G06F 1/3212; G06F 1/3296

(52) U.S. Cl. CPC G06F 1/3212; G06F 1/3296

(57) ABSTRACT

The described technology provides a system on chip (SOC) including a charger configured to receive power from a power supply unit (PSU), a rechargeable battery, a PSU power measurement unit configured to determine current level I_PSU output from the PSU and a voltage level Vpsu at the output of the PSU and to communicate the I_PSU and the Vpsu to a power controller on the SOC, and a battery power measurement unit configured to determine I_BAT output from the rechargeable battery and voltage level Vsys at the output of the battery unit and to communicate the I_BAT and the Vsys to the power controller on the SOC, wherein the power controller is configured to determine level of power (P_PSU) input by the PSU into the charger based at least in part on the I_PSU and the Vpsu, determine, based at least in part on the P_PSU and the IBAT that the battery is operating in a plugged-in not charging (PINC) state, in response to determining that the battery is operating in the PINC state, adjusting, by the power controller on the SOC, a power supply limit (Psys_LIMIT) by the power controller on the SOC, and changing the power supplied to one or more components on the SOC based at least in part on the Psys_LIMIT.

### BACKGROUND

In recent years, the field of computing devices (such as laptops) and mobile devices (e.g., cellular phones) has increased dramatically. Increasingly, such computing devices and mobile devices may include chargeable battery that may be charged using a Universal Serial Bus (USB) interface that is plugged into a power supply unit (PSU). For example, these mobile devices may be charged by coupling a USB cable to the mobile device and also coupling the USB cable to a power source (e.g., a wall socket or computer system).

### SUMMARY

The described technology provides a system on chip (SOC) including a charger configured to receive power from a power supply unit (PSU), a rechargeable battery, a PSU power measurement unit configured to determine current level I_PSU output from the PSU and a voltage level Vpsu at the output of the PSU and to communicate the I_PSU and the Vpsu to a power controller on the SOC, and a battery power measurement unit configured to determine I_BAT output from the rechargeable battery and voltage level Vsys at the output of the battery unit and to communicate the I_BAT and the Vsys to the power controller on the SOC, wherein the power controller is configured to determine level of power (P_PSU) input by the PSU into the charger based at least in part on the I_PSU and the Vpsu, determine, based at least in part on the P_PSU and the IBAT that the battery is operating in a plugged-in not charging (PINC) state, based at least in part on determining that the battery is operating in the PINC state, adjusting, by the power controller on the SOC, a power supply limit (Psys_LIMIT) by the power controller on the SOC, and changing the power supplied to one or more components on the SOC based at least in part on the Psys_LIMIT.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an SOC based system including a charger that is powered from a power supply and an SOC based power controller.

FIG. 2 illustrates an alternative block diagram of an example SOC power and performance controller.

FIG. 3 illustrates example SOC self-regulation graphs.

FIG. 4 illustrates an example a flow diagram of plugged in not charging (PINC) protection control operations as per the system disclosed herein.

FIG. 5 illustrates example operations of the SOC power and performance control system disclosed herein.

FIG. 6 illustrates an example computing system that may be useful in implementing the SOC power and performance control system disclosed herein.

### DETAILED DESCRIPTIONS

In recent years, the field of computing devices (such as laptops) and mobile devices (e.g., cellular phones) has increased dramatically. Increasingly, such computing devices and mobile devices may include chargeable battery that may be charged using a Universal Serial Bus (USB) interface that is plugged into a power supply unit (PSU). For example, these mobile devices may be charged by coupling a USB cable to the mobile device and also coupling the USB cable to a power source (e.g., a wall socket or computer system). However, depending on the levels of power consumed by the computing device or the mobile device, the battery may not charge even when the device is plugged into the PSU.

Modern computing devices are generally smart devices that are designed to monitor power levels and set power-based performance limits. For example, system on chips (SOCs) used to implement such smart devices typically are configured to monitor and control the power at the SOC level. Consequently, users of the SOCs can use such power limits to control the operations and performance of the systems built thereupon. For example, if the user of the SOC sets 25 W to be the power level limit, the SOC monitors the system level power usage and when the 25 W usage level is reached, it may throttle back its own processing power. However, the SOC cannot affect any other operations of the devices built thereupon.

The SOCs may be powered using a number of different power sources, such as battery, plug-in power source, etc. For the SOCs and the systems built thereupon, the amount of power coming in from the power source is not monitored by the SOCs. The PSU provided for a given system may have a specified level, such as for example, 60 W. However, in reality, the power delivered by the PSU may vary about the specified level of a number of reasons, such as temperature variations or variations based at least in part on other environmental factors. The implementations disclosed herein provides methods of monitoring the amount of power coming in from the charging sources. Specifically, the implementations disclosed herein provide methods of monitoring the power coming from a power supply unit (PSU) and make one or more decisions regarding the processes running on the SOC. In one implementation, the processes running on one or more processors on the SOC may be limited based at least in part on the incoming power such that the processes do not tap into reserve power available through battery.

Furthermore, the implementations disclosed herein also provides a method of monitoring the amount of energy going from a battery power source into the SOC based system. Subsequently, the measured level of energy may be used as a signal for determining that the system implemented on the SOC is consuming more energy than the PSU can provide. For example, the amount of energy going from a battery power source into the SOC based system may be compared to a threshold and when the level exceeds this threshold, a signal can be generated to the SOC based system to curtail one or more processes so as to reduce the amount of power consumed by the one or more processors or other components on the SOC.

Additionally, implementations disclosed herein provide am SOC driven plugged-in-not-charging (PINC) prevention method. Specifically, the implementations disclose an algorithm and hardware/software control method used for adaptive PINC protection in battery-operated computing devices. PINC typically occurs under corner cases, especially when the total system power (Psys) is consistently close to the PSU rating. Various factors contribute to PINC, such as PSU rating, PSU variation, PCB variation, power delivery component variation, ambient temperature, PSU aging, and charger & PSU transient response. PINC leads to a poor user experience and must be avoided unless constrained by reliability safety limitations.

Implementations disclosed herein allow achieving a balanced fixed Psys optimal allocation to meet both system performance and PINC protection is inherently challenging due to the wide range of variables involved. Therefore, we propose an adaptive PINC protection control method through adaptive Psys allocation to ensure effective PINC protection. Specifically, the proposed method operates directly via the SOC with data acquisition from the system. Therefore, the SOC reduces Psys_LIMIT to avoid PINC or increase Psys_LIMIT to enhance SOC performance, as the SOC itself rebalances CPU/NPU/GPU to maximize user experience. As a result, the method disclosed herein ensures optimal system power and performance balancing under any conditions managed by the hardware SOC, with minimal involvement of software resources.

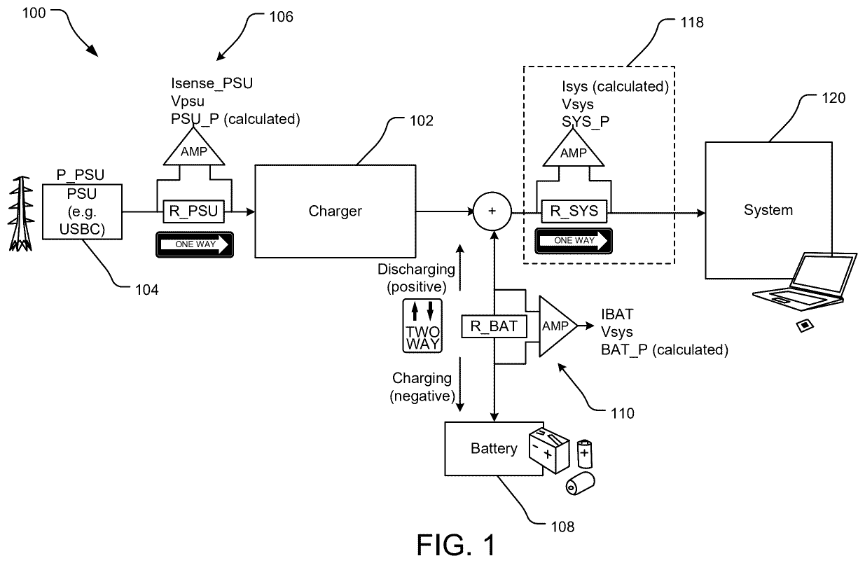

Now referring to FIG. 1, it illustrates a power control system 100 including a charger 102 that is powered from a power supply 104. The charger 102 outputs power that is used to run a computing system 120. For example, the computing system 120 may be a tablet system that is configured on an SOC. The computing system 120 may have a number of components such as processors, memory, displays, input devices, etc., that consume power. The power control system 100 also includes a battery unit 108 that is used as a secondary source of power for the computing system 120. The battery unit 108 may be a rechargeable battery unit 120 that is configured to be charged from the power output from the charger 102. Furthermore, when the power supply 104 is not available, or when the power supplied from the power supply 104 is not sufficient for the power used by the computing system 120, the battery unit 108 may supply power to the computing system 120.

For example, the computing system 120 is using one hundred (100) watts while the power supply 104 is capable of providing only eighty (80) watts of power. In this case, the computing system 120 has to pull power from the battery unit 108. When the computing system 120 uses power from the battery unit 108 even when the charger 102 is plugged into the power supply 104, the computing system 120 is referred to as operating in a plugged-in not charging (PINC) state. Specifically, in the PINC state, the battery unit 108 is discharging, instead of being charged using the power from the power supply 104. In an implementation disclosed herein, the power control system 100 is configured to prevent the computing system to operate so at to cause the battery unit 108 to be in the PINC state.

In an implementation disclosed herein, the power control system 100 includes a power supply unit (PSU) power measurement unit 106 that is configured between the power supply 104 and the charger 102 to measure the power being delivered by the power supply 104. The PSU power measurement unit 106 measures the current level I_PSU output from the power supply 104 and the voltage level Vpsu at the output of the power supply 104 and uses the I_PSU and the Vpsu to calculate the PSU_P, which is the power output from the power supply 104 and input into the charger 102. The calculated value of the PSU_P is communicated to the computing system 120.

Furthermore, the power control system 100 may also include a battery power measurement unit 110 that measures the power supplied by the battery unit 108 into the computing system 120. The battery power measurement unit 110 measures the current level I_battery output from the battery unit 108 and the voltage level Vsys at the output of the battery unit 108 and uses the I_battery and the Vsys to calculate the battery_P, which is the power output from/input into the battery unit 108. Depending on the value of the I_battery being positive (indicating the battery unit 108 providing power into the computing system 120) or negative (indicating the battery unit 108 being charged by the charger 10), the value of the BAT_P may be positive (indicating a PINC state) or negative. The calculated value of the BAT_P is communicated to the computing system 120. Measuring current level I_PSU output from the power supply 104 and the voltage level Vpsu at the output of the power supply 104 as well as the current level I_battery output from the battery unit 108 and the voltage level Vsys at the output of the battery unit 108 provides technical benefit in that the power control system 100 is able to use these measured values to independently calculate the power output from the power supply 104 as well as the power inoput/output by the battery unit 108.

The computing system 120 may evaluate the values of the PSU_P (the power output from the power supply 104) and the BAT_P (power output from/input into the battery unit 108) to make determination to control various processes within the computing system 120. For example, if the BAT_P is positive, indicating PINC state, the computing system 120 may change the operation of the computing system 120 to a lower power mode. In one implementation, in such lower power mode, the computing system 120 may reduce the brightness of one or more output units, such as a screen, a back-lit keyboard, etc.

In an alternative implementation, the computing system 120 may compare the PSU_P and the BAT_P to various thresholds and based at least in part on these thresholds modify various operating parameters of the computing system 120. For example, one such modification may be to slow the number of operations performed by a CPU of the computing system 120. In one implementation, the thresholds may be set up on the SOC implementing the computing system 120 using various control registers. Alternatively, Modifications may include changes to the core clock speeds of CPUs, GPUs, and NPUs, variations in power supply rail voltages, dynamic voltage and frequency scaling (DVFS), selective core shutdown (partial core parking), power gating; adjustments to Windows Energy Performance Preference (EPP) settings, and alterations to package power limits (such as PL1 and PL2).

In an alternative implementation, the measured values of the PSU_P and the battery_P are communicated to the SOC that is used to configure the computing system 120. In such an implementation, the SOC may include various registers to compare the measured values of the PSU_P and the battery_P and automatically throttle one or more SOC operations based at least in part on the comparison of the measured values of the PSU_P and the BAT_P. In the illustrated implementation, the power control system 100 also includes a system power measurement unit 118 that measures the current and voltage at the system input level to determine the power SYS_P input to the system 120. If the power drawn by the system (SYS_P) exceeds the charger's output—calculated as PSU power multiplied by charger efficiency, this may indicate a PINC (plug in not charging) condition, where the battery is discharging to support the system load rather than charging.

The implementations disclosed herein provide significant advancement in power and performance optimization, offering the system 120 or the SOC that is used to configure the system 120 to throttle one or more processes to ensure that the system 120 avoids excessive allocation of power to any component or processes. Specifically, measuring the power PSU_P at the input level to the charger 102 and the power BAT_P drawn or supplied by the battery 108 and communicating it to the system 120 ensures that the system 120 manages power in such a manner so as not to drain the battery 108 excessively.

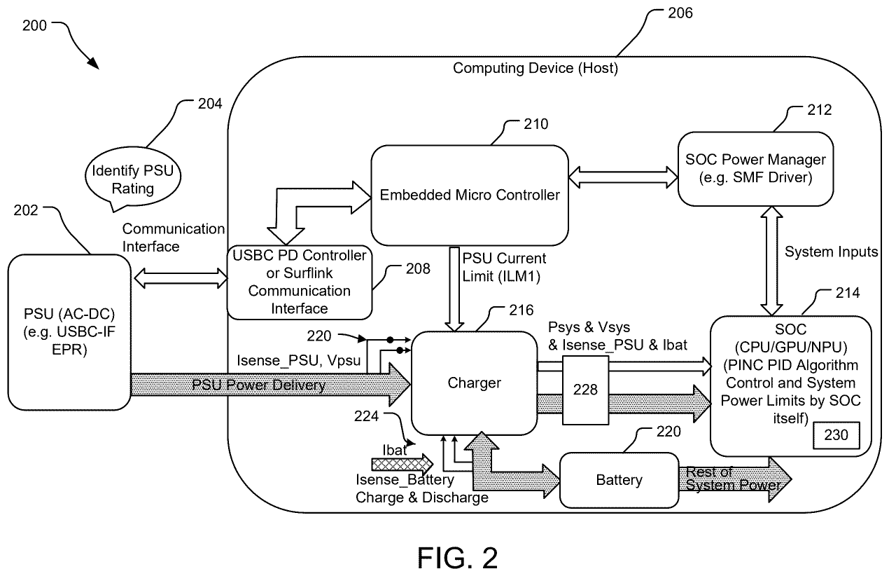

FIG. 2 illustrates a block diagram of an SOC power and performance controller (SOC PPC) 200. The SOC PPC system 200 may be used to control power levels used by various components and processes of a computing device 206. For example, the computing device 206 may be tablet, a laptop, a mobile device, etc., that is configured on an SOC. The computing device 206 may be connected to a power supply unit (PSU) 202 such as an AC-DC power supply with a PSU rating of 204. For example, the PSU 202 may be connected to an embedded microcontroller 210 via a communication interface 208. Furthermore, the PSU 202 may provide power to a charger 216 of the computing device 206. The embedded micro controller 210 may also be configured to generate and communicate a PSU current limit ILM1 to the charger.

The charger 216 may be connected to a battery 220 to provide power to the battery 220 or to receive power from the battery 220. The battery 220 is configured to various components of the computing system 206. Furthermore, the computing device 206 may also include an SOC power manager 212 that may be configured to communicate with an SOC 214. For example, the SOC 214 may be used to configure various processors such as CPUs, GPUs, NPUs, memory, registers, communication buses, etc., of the computing device 206. In the illustrated implementation, the SOC 214 also stores a plugged in not charging (PINC) algorithm. For example, the PINC algorithm may be implemented using a proportional-integral-derivative (PID) controller. In one implementation, the PID controller receives input data from the SOC power manager 212, the charger 216, the battery 220, etc. Subsequently, the PID controller may calculate the difference between the actual value and the desired setpoint, and adjusts outputs to control voltage supplied to various components implemented on the SOC.

In various implementations disclosed herein, the SOC 214 may communicate various power control signals including signals to limit power to one or more SOC components to the SOC power manager 212. Alternatively, the SOC 214 may include a component power manager 230 that controls, using the PID various power levels for the components implemented on the SOC 214, such as a CPU, GPU, NPU, etc. For example, the component power manager 230 may set a Psys_LIMIT that limits the power to the components. In one implementation, the component power manager 230 may use the P_PSU and IBAT to determine the Psys_LIMIT that limits power supplied to one or more components on the SOC.

Allowing the component power manager 230 that controls, using the PID various power levels for the components implemented on the SOC 214, such as a CPU, GPU, NPU, including increases and decreases to Psys_LIMIT provides additional technical benefits to the SOC PPC 200 in that the SOC PPC 200 is able to precisely manage the power levels based at least in part on the power drain on the battery 220. Thus, the component power manager 230 may increase the Psys_LIMIT if the power drain on the battery 220 is high and decrease the Psys_LIMIT if the power drain on the battery 220 is low.

In the illustrated implementation, the computing device 206 may also include a PSU power measurement unit 220 that measures the input current Isense_PSU, and the input voltage Vpsu that are input by the PSU 202 into the charger 216. The PSU power measurement unit 220 may determine the input power PSU_P based at least in part on the input current Isense_PSU, and the input voltage Vpsu and communicate the input power PSU_P to the SOC 214 via the embedded micro controller 210 and the SOC power manager 212. Similarly, a battery power measurement unit 224 measures the current Isense_battery, and the voltage V_battery between the battery 220 and the charger 216. The battery power measurement unit 224 may determine the power battery_P based at least in part on the Isense_battery, and the voltage V_battery and communicate the power battery_P to the SOC 214 via the embedded micro controller 210 and the SOC power manager 212. Additionally, a system power measurement unit 228 measures the voltage Vsys and power levels Psys that are output from the charger to the SOC.

In the illustrated implementation, the SOC 214 evaluates various input level at the charger, such as the Isense_PSU, the Vpsu, and the PSU_P to determine power level throttling for various processors on the SOC 214. For example, the SOC 214 may compare the PSU_P to a threshold and depending on the comparison, it may throttle the power available to the processors. For example, if the PSU_P is at 100 W and the peak power level of the SOC 114 is at 120 W, the SOC 114 may limit power to one or more of the CPUs so that the total power does not exceed 90 W.

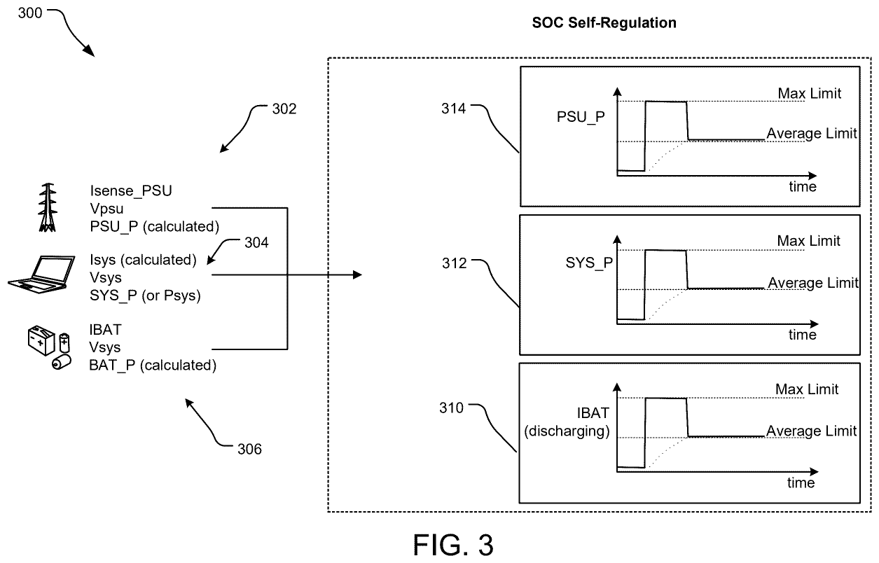

Furthermore, the SOC 114 may also evaluate any PINC condition at the battery 220 to throttle power consumption by one or more processes running on the SOC 214. For example, if the battery 220 is supplying power even when the computing device 206 is plugged into the PSU 202, the SOC 214 may limit power supplied to one or more of the processors on the SOC 214. In one implementation, the throttling of the power to various components on the SOC 214 may be based at least in part on various thresholds as further described below in FIG. 3.

Specifically, FIG. 3 illustrates SOC self-regulation graphs 300. The SOC self-regulation graphs 300 receive various input parameters related to the power levels of the SOC. Specifically, the SOC self-regulation graphs 300 receive PSU power input parameters 302 including PSU input current Isense_PSU, PSU input voltage level Vpsu, and the PSU input power level PSU_P, which is calculated using the Isense_PSU and the Vpsu. Furthermore, the self-regulation graphs 300 receive system power parameters 304 that are output from a charger and made available to the SOC. The system power parameters include Vsys, which is the power level available to the SOC and Psys, which is the power level in watts that is available to the SOC. The system current Isys may be calculated from the Psys and the Vsys.

The SOC self-regulation graphs 300 also receive battery power input parameters 306 including battery input/output current IBAT, battery input/output voltage level Vsys, and the battery input/output power level BAT_P, which is calculated using IBAT and the Vsys.

A graph 312 illustrates SOC managing the system power P_SYS between maximum P_SYS and minimum P_SYS based at least in part on the measured values of P_SYS output by the charger. On the other hand, graph 310 illustrates a graph based at least in part on the implementations disclosed herein where the SOC manages the power limits of various components on the SOC based at least in part on discharge current levels of the battery, Ibattery_discharge. Similarly, the graph 314 illustrates a graph based at least in part on other implementations disclosed herein where the SOC manages the power limits of various components on the SOC based at least in part on PSU_P, which indicates the power delivered to the charger from the PSU. In one implementation, the PSU_P may be calculated based at least in part on measured values of current Isense_PSU and voltage Vpsu at the input of the charger.

In implementations disclosed herein, the SOC adaptively uses the discharge current levels of the battery and or the PSU_P to control PINC condition of the battery. For example, in one implementation, the SOC may allocate initial total system power (Psys_LIMIT) based at least in part on a typical corner of PD (power delivery). i.e. considers PSU power rating at typical corner, non-ideal charger transient, and PCB loss, etc. Specifically, a power controller configured on the SOC adjusts the Psys_LIMIT based at least in part on PSU power rating at a typical corner, where the typical corner represents operation of the PSU in typical operating conditions. For example, a typical corner case may represent an operating condition where the total system power Psys is close to nominal PSU power P_PSU_NOM. P_PSU_NOM refers to the PSU's nominal output voltage and currents—including both the maximum sustainable and peak currents—which can vary by a certain percentage depending on operating temperature, humidity, and similar environmental conditions. This condition may represent a corner condition that is start of a battery plugged in not charging (PINC) condition. This implementation helps the SOC to avoid excessive initial Psys_LIMIT allocation and not to introduce a thermally limited chassis and battery that may cause PINC. In this implementation, the SOC may allocate Psys_LIMIT at less than or equal to P_PSU_MIN to address PSU nominal corner cases, cases with typical component power loss, etc. Adjusing the Psys_LIMIT based at least in part on PSU power rating at a typical corner allows technical benefit in that the Psys_LIMIT is managed based at least in part on most typical operating conditions of the PCB, thus avoiding manageing Psys_LIMIT based at least in part on extreme or fringe operating conditions of the PCB.

An alternative implementation addresses cases when no thermally interrupted condition is allowed (i.e., when chassis and battery temps are not to invoke charging throttle). Here, when Psys is read close to P_PSU_MIN and PINC is detected (e.g., when battery RSOC is decreasing over defined time stamp with a PSU attached), the SOC may enforce the expected battery charge rate by stepping down the Psys_LIMIT. For example, the SCO may step down the Psys_LIMIT successively to 93% to 92% to 91% to 90% and so on of PSU until average battery charging is margining at the defined rate (e.g. 0.1 capacity or 0.2 capacity charge rate). Alternatively, when Psys readings are close to P_PSU_MIN but when PINC is not detected and the battery is charging at higher than a threshold rate, such as at more than 0.2 C, the SOC may step up the Psys_LIMIT such that the charge rate is greater than the minimum battery charge rate. For example, the SOC may step up the Psys_LIMIT to 93% to 94%, 95%, 96% so on of PSU until charge rate becomes limited to the defined rate (e.g. 0.2 C charge rate). This implementation provides the optimal trade-off point of performance for the SOC aligned with better user experience due to charging of the battery.

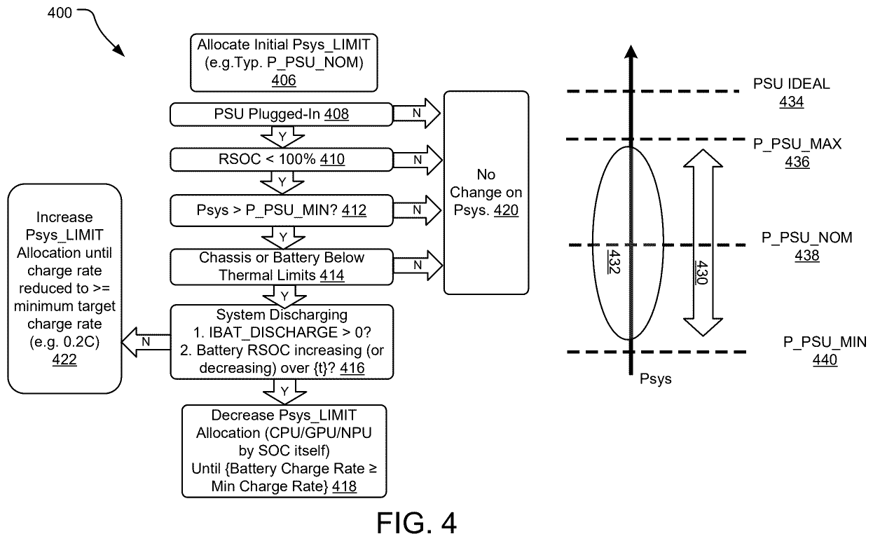

FIG. 4 illustrates a flow diagram of plugged in not charging (PINC) protection control operations 400. Specifically, the operations 400 illustrate an implementation where battery charge rate is interrupted and/or limited. For example, the battery charge rate may be interrupted and/or limited based at least in part on an input related to chassis temperature limit, battery temperature reliability limit, or other reliability inputs from the SOC. Specifically, an operation 406 allocates initial Psys_limit. For example, the Psys_limit may limit the power of the PSU to some nominal limit, given by P_PSU_NOM.

Subsequently, an operation 408 determines if the system is plugged into a PSU. If the system is not plugged in, at per operation 420, no change to the power of the system, Psys is required. If the system is plugged into a PSU, an operation 410 determines if relative state of charge (RSOC) is less than one hundred percentages (100%). Here the RSOC is the current level of battery charge as compared to the maximum battery charge level. If the RSOC is equal to 100%, as per operation 420, no change to the power of the system, Psys is required. If the RSOC is less than 100%, an operation 412 determines if Psys is greater than P_PSU_MIN, where P_PSU_MIN indicates the minimum power required for operating the SOC. For example, the P_PSU_MIN may be equal to PSU worst corner plus PCB loss from PSU output to system. Using the RSOC to manage the Psys_LIMIT provides technical benefit in that it minimizes unnecessary changes to the Psys_LIMIT.

If the Psys is not greater than P_PSU_MIN, as per operation 420, no change to the power of the system, Psys is required. However, if Psys is greater than P_PSU_MIN, an operation 414 determines if the chassis or the battery are below thermal limits. If no, as per operation 420, no change to the power of the system, Psys is required. However, if the chassis or the battery are below thermal limits, an operation 416 determines that the system is discharging. Specifically, the operation 416 determines whether the battery discharge current IBAT_DISCHARGE is greater than zero and if the battery relative state of charge (RSOC) is increasing over time. If either of these conditions is right, an operation 418 may decrease the Psys_LIMIT allocation to various SOC components, such as CPU, GPU, NPU, etc. Specifically, such decrease in Psys_LIMIT for the SOC components is affected by the SOC itself. In one implementation, the SOC decreases the Psys_LIMIT for the SOC components until the battery discharge rate gets back to above a minimum battery discharge rate. Decreasing the Psys_LIMIT for SOC until the battery discharge rate gets back to above a minimum battery discharge rate provides technical benefit in that the battery is not unnecessarily discharged below the minimum battery discharge rate.

However, if both of these conditions at operation 416 are not met (that is, the battery discharge current IBAT_DISCHARGE is not greater than zero and the battery relative state of charge (RSOC) is not increasing over time), an operation 422 increases the limit of system power Psys_LIMIT allocation to various SOC components until the discharge rate IBAT_DISCHARGE is reduced to be below a minimum target charge rate. For example, such minimum target charge rate may be 20% of the maximum battery charge rate.

FIG. 4 also illustrates the adaptive Psys range 430 resulting from the operations 400. Specifically, the adaptive Psys, which is the power delivered to various SOC components may vary between PSU_IDEAL 434, P_PSU_MAX 436, P_PSU_NOM 438, and P_PSU_MIN 440. Here P_PSU represents the power provided by the PSU to a charger. Furthermore, FIG. 4 also illustrates the range 432 of the actual power delivered (PD) to various SOC components. The PD range 432 may depend on power delivered by the PSU, charger efficiency, etc. As illustrated, the PD range 432 may vary between PSU_MAX 436 and PSU_MIN 440.

The implementations disclosed herein provide a number of different methods of avoiding or reducing the likelihood of the battery on an SOC operating in the PINC condition. Specifically, in one implementation, values of sensed Psys are compared with P_PSU_MIN, Ibattery_discharge rate is evaluated to be above zero, and battery RSOC is evaluated to determine if it is increasing. These operations may be performed by the SOC itself. In another implementation, values of Isense_PSU and Vpsu at the input of the charge are used together with Ibattery_discharge and Vsys at the SOC. Specifically, the P_PSU+Ibattery_discharge×Vsys is compared with P_PSU_MIN (here P_PSU is given by Isense_PSU×Vpsu). In a third method, P_sys is compared with P_PSU×EFF_charger, wherein the EFF_charger gives the efficiency of the charger in percentages.

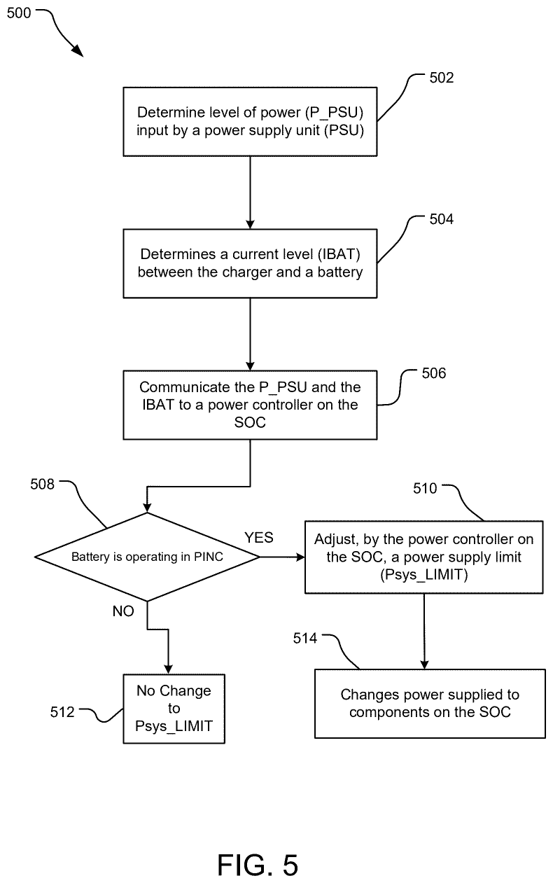

FIG. 5 illustrates example operations 500 of the SOC power and performance control system disclosed herein. Specifically, an operation 502 determines level of power (P_PSU) input by a power supply unit (PSU) into a charger of a computing system implemented on an SOC. Subsequently, an operation 504 determines a current level (IBAT) between the charger and a battery, wherein the battery is configured on the SOC so as to be charged by the charger and to provide power to the charger.

An operation 506 communicates the P_PSU and the IBAT to a power controller on the SOC. An operation 508 determines based at least in part on the P_PSU and the IBAT if the battery is operating in a plugged-in not charging (PINC) state. In response to determining that the battery is operating in the PINC state, an operation 510 adjusts, by the power controller on the SOC, a power supply limit (Psys_LIMIT) by the power controller on the SOC. If the battery is not operating in PINC, at 512, no change is made to the Psys_LIMIT. Subsequently, an operation 514 changes the power supplied to one or more components on the SOC based at least in part on the Psys_LIMIT.

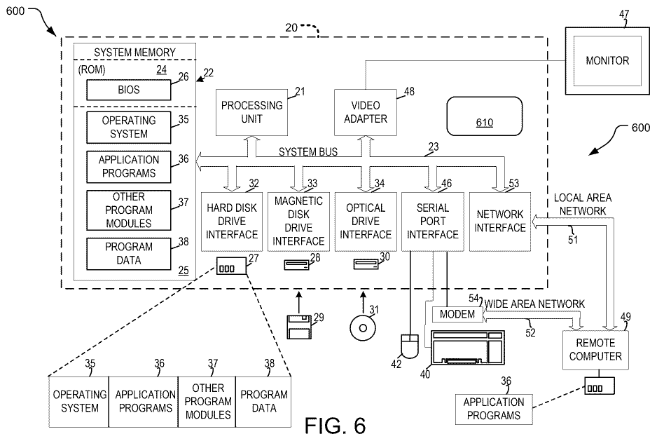

FIG. 6 illustrates an example system 600 that may be useful in implementing the SOC power and performance control system disclosed herein. The example hardware and operating environment of FIG. 6 for implementing the described technology includes a computing device, such as a general-purpose computing device in the form of a computer 20, a mobile telephone, a personal data assistant (PDA), a tablet, smart watch, gaming remote, or other type of computing device. In the implementation of FIG. 6, for example, the computer 20 includes a processing unit 21, a system memory 22, and a system bus 23 that operatively couples various system components, including the system memory 22 to the processing unit 21. There may be only one or there may be more than one processing units 21, such that the processor of a computer 20 comprises a single central-processing unit (CPU), or a plurality of processing units, commonly referred to as a parallel processing environment. The computer 20 may be a conventional computer, a distributed computer, or any other type of computer; the implementations are not so limited.

In the example implementation of the computing system 600, the computer 20 also includes a SOC power control system 610, such as the SOC power and performance control system disclosed herein. The SOC power control system 610 may communicate with power sources 620 to control the level of power provided by the power sources 620.

The system bus 23 may be any of several types of bus structures, including a memory bus or memory controller, a peripheral bus, a switched fabric, point-to-point connections, and a local bus using any of a variety of bus architectures. The system memory 22 may also be referred to as simply the memory and includes read-only memory (ROM) 24 and random-access memory (RAM) 25. A basic input/output system (BIOS) 26, contains the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The computer 20 may be used to implement a SOC power and performance control system disclosed herein. In one implementation, a frequency unwrapping module, including instructions to unwrap frequencies based at least in part on the sampled reflected modulations signals, may be stored in memory of the computer 20, such as the read-only memory (ROM) 24 and random-access memory (RAM) 25.

Furthermore, instructions stored on the memory of the computer 20 may be used to generate a transformation matrix using one or more operations disclosed in FIG. 8. Similarly, instructions stored on the memory of the computer 20 may also be used to implement one or more operations of FIG. 4. The memory of the computer 20 may also one or more instructions to implement the SOC power and performance control system disclosed herein.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide non-volatile storage of computer-readable instructions, data structures, program modules and other data for the computer 20. It should be appreciated by those skilled in the art that any type of tangible computer-readable media may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus 23, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device, or other common network node, and typically includes many or all of the elements described above relative to the computer 20. The logical connections depicted in FIG. 8 include a local-area network (LAN) 51 and a wide-area network (WAN) 52. Such networking environments are commonplace in office networks, enterprise-wide computer networks, intranets, and the Internet, which are all types of networks.

When used in a LAN-networking environment, the computer 20 is connected to the local area network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of communications devices for establishing a communications link between the computers may be used.

In an example implementation, software, or firmware instructions for the SOC power control system 610 may be stored in system memory 22 and/or storage devices 29 or 31 and processed by the processing unit 21. SOC power and performance control system scheme and data may be stored in system memory 22 and/or storage devices 29 or 31 as persistent data-stores.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments of SOC power and performance control system may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain function. The instructions may be implemented using any suitable high-level, low-level, object-oriented, visual, compiled and/or interpreted programming language.

The SOC power and performance control system disclosed herein may include a variety of tangible computer-readable storage media and intangible computer-readable communication signals. Tangible computer-readable storage can be embodied by any available media that can be accessed by the SOC power and performance control system disclosed herein and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the SOC power and performance control system disclosed herein. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals moving through wired media such as a wired network or direct-wired connection, and signals moving through wireless media such as acoustic, RF, infrared and other wireless media.

A system disclosed herein includes a a power supply unit (PSU) configured to supply power to a system on chip (SOC), a charger configured to receive power from the PSU, a rechargeable battery, a PSU power measurement unit configured to determine current level I_PSU output from the PSU and a voltage level Vpsu at the output of the PSU and to communicate the I_PSU and the Vpsu to a power controller on the SOC, and a battery power measurement unit configured to determine I_BAT output from the rechargeable battery and voltage level Vsys at the output of the battery unit and to communicate the I_BAT and the Vsys to the power controller on the SOC, wherein the power controller is configured to determine level of power (P_PSU) input by the PSU into the charger based at least in part on the I_PSU and the Vpsu, determine, based at least in part on the P_PSU and the IBAT that the battery is operating in a plugged-in not charging (PINC) state, based at least in part on determining that the battery is operating in the PINC state, adjusting, by the power controller on the SOC, a power supply limit (Psys_LIMIT) by the power controller on the SOC, and changing the power supplied to one or more components on the SOC based at least in part on the Psys_LIMIT.

A method disclosed herein includes determining level of power (P_PSU) input by a power supply unit (PSU) into a charger of a computing system implemented on an SOC, determining a current level (IBAT) between the charger and a battery, wherein the battery is configured on the SOC so as to be charged by the charger and to provide power to the charger, communicating the P_PSU and the IBAT to a power controller on the SOC, determining, based at least in part on the P_PSU and the IBAT that the battery is operating in a plugged-in not charging (PINC) state, based at least in part on determining that the battery is operating in the PINC state, adjusting, by the power controller on the SOC, a power supply limit (Psys_LIMIT) by the power controller on the SOC, and changing the power supplied to one or more components on the SOC based at least in part on the Psys_LIMIT.

A system on chip (SOC) disclosed herein includes a charger configured to receive power from a power supply unit (PSU), a rechargeable battery, a PSU power measurement unit configured to determine current level I_PSU output from the PSU and a voltage level Vpsu at the output of the PSU and to communicate the I_PSU and the Vpsu to a power controller on the SOC, and a battery power measurement unit configured to determine I_BAT output from the rechargeable battery and voltage level Vsys at the output of the battery unit and to communicate the I_BAT and the Vsys to the power controller on the SOC, wherein the power controller is configured to determine level of power (P_PSU) input by the PSU into the charger based at least in part on the I_PSU and the Vpsu, determine, based at least in part on the P_PSU and the IBAT that the battery is operating in a plugged-in not charging (PINC) state, based at least in part on determining that the battery is operating in the PINC state, adjusting, by the power controller on the SOC, a power supply limit (Psys_LIMIT) by the power controller on the SOC, and change the power supplied to one or more components on the SOC based at least in part on the Psys_LIMIT

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. A system, comprising:
a power supply unit (PSU) configured to supply power to a system on chip (SOC);
a charger configured to receive power from the PSU;
a rechargeable battery;
a PSU power measurement unit configured to determine current level I_PSU output from the PSU and a voltage level Vpsu at the output of the PSU and to communicate the I_PSU and the Vpsu to a power controller on the SOC; and
a battery power measurement unit configured to determine I_BAT output from the rechargeable battery and voltage level Vsys at the output of the battery unit and to communicate the I_BAT and the Vsys to the power controller on the SOC;
wherein the power controller is configured to:
determine level of power (P_PSU) input by the PSU into the charger based at least in part on the I_PSU and the Vpsu;
determine, based at least in part on the P_PSU and the IBAT that the battery is operating in a plugged-in not charging (PINC) state;
based at least in part on determining that the battery is operating in the PINC state, adjusting, by the power controller on the SOC, a power supply limit (Psys_LIMIT) by the power controller on the SOC; and
changing the power supplied to one or more components on the SOC based at least in part on the Psys_LIMIT.

2. The device of claim 1, wherein the power controller is further configured to adjust the Psys_LIMIT based at least in part on a PSU power rating at a typical corner.

3. The device of claim 2, wherein the power controller is further configured to evaluate if the battery is discharging and based at least in part on determining that the battery is discharging, decreasing the Psys_LIMIT until battery discharge rate is greater than a minimum charge rate, wherein the minimum charge rate represents minimum charge rate of the charger by the battery.

4. The device of claim 3, wherein the power controller is further configured to based at least in part on determining that the battery is discharging increasing the Psys_LIMIT until charger charge rate is substantially equal to a minimum charge rate, wherein the charger charge rate represents the rate at which the battery is charging the charger.

5. The device of claim 1, wherein the power controller is further configured to evaluate a battery relative state of charge (RSOC) by the power controller on the SOC and based at least in part on determining that the RSOC is below and that a total power Psys delivered to the SOC is above a minimum PSU power P_PSU_MIN, reducing the Psys_LIMIT.

6. The device of claim 1, wherein determining, based at least in part on the P_PSU and the IBAT that the battery is operating in the plugged-in not charging (PINC) state, further comprising comparing the total power Psys delivered to the SOC to nominal PSU power P_PSU_NOM.

7. The device of claim 6, wherein the power controller is further configured to, based at least in part on determining that the Psys delivered to the SOC is greater than nominal PSU power P_PSU_NOM, reducing the Psys_LIMIT.

8. A method comprising:
determining level of power (P_PSU) input by a power supply unit (PSU) into a charger of a computing system implemented on an SOC;
determining a current level (IBAT) between the charger and a battery, wherein the battery is configured on the SOC so as to be charged by the charger and to provide power to the charger;
communicating the P_PSU and the IBAT to a power controller on the SOC;
determining, based at least in part on the P_PSU and the IBAT that the battery is operating in a plugged-in not charging (PINC) state;
based at least in part on determining that the battery is operating in the PINC state, adjusting, by the power controller on the SOC, a power supply limit (Psys_LIMIT) by the power controller on the SOC; and
changing the power supplied to one or more components on the SOC based at least in part on the Psys_LIMIT.

9. The method of claim 8, wherein the power controller on the SOC is further configured to adjust the Psys_LIMIT based at least in part on a PSU power rating at a typical corner.

10. The method of claim 8, further comprising evaluating if the battery is discharging and based at least in part on determining that the battery is discharging, decreasing the Psys_LIMIT until battery discharge rate is greater than a minimum charge rate, wherein the minimum charge rate represents minimum charge rate of the charger by the battery.

11. The method of claim 10, further comprising based at least in part on determining that the battery is discharging increasing the Psys_LIMIT until charger charge rate is equal to a minimum charge rate, wherein the charger charge rate represents the rate at which the battery is charging the charger.

12. The method of claim 8, further comprising evaluating a battery relative state of charge (RSOC) by the power controller on the SOC and based at least in part on determining that the RSOC is below and that a total power Psys delivered to the SOC is above a minimum PSU power P_PSU_MIN, reducing the Psys_LIMIT.

13. The method of claim 8, wherein determining, based at least in part on the P_PSU and the IBAT that the battery is operating in the plugged-in not charging (PINC) state further comprising comparing a total power Psys delivered to the SOC to nominal PSU power P_PSU_NOM.

14. The method of claim 8, further comprising:
determining a current level Isense_PSU at the input of the charger;
determining a voltage level Vpsu at the input of the charger; and
communicating the Isense_PSU and the Vpsu to the power controller on the SOC, wherein determining P_PSU further comprising determining P_PSU based at least in part on the Isense_PSU and the Vpsu.

15. The method of claim 8, further comprising:
determining a current level Ibattery_discharge at the battery;
determining a voltage level Vsys output by the charger; and
communicating the Ibattery_discharge and the Vsys to the power controller on the SOC; and
determining power delivered to the SOC P_sys based at least in part on the Ibattery_discharge and the Vsys.

16. A system on chip (SOC), comprising:
a charger configured to receive power from a power supply unit (PSU);
a rechargeable battery;
a PSU power measurement unit configured to determine current level I_PSU output from the PSU and a voltage level Vpsu at the output of the PSU and to communicate the I_PSU and the Vpsu to a power controller on the SOC; and
a battery power measurement unit configured to determine I_BAT output from the rechargeable battery and voltage level Vsys at the output of the battery unit and to communicate the I_BAT and the Vsys to the power controller on the SOC;
wherein the power controller is configured to:
determine level of power (P_PSU) input by the PSU into the charger based at least in part on the I_PSU and the Vpsu,
determine, based at least in part on the P_PSU and the IBAT that the battery is operating in a plugged-in not charging (PINC) state;
based at least in part on determining that the battery is operating in the PINC state, adjust, by the power controller on the SOC, a power supply limit (Psys_LIMIT) by the power controller on the SOC; and
change the power supplied to one or more components on the SOC based at least in part on the Psys_LIMIT.

17. The SOC of claim 16, wherein the power controller is further configured to adjust the Psys_LIMIT based at least in part on a PSU power rating at a typical corner.

18. The SOC of claim 17, wherein the power controller is further configured to evaluate if the battery is discharging and based at least in part on determining that the battery is discharging, decreasing the Psys_LIMIT until battery discharge rate is greater than a minimum charge rate, wherein the minimum charge rate represents minimum charge rate of the charger by the battery.

19. The SOC of claim 17, wherein the power controller is further configured to based at least in part on determining that the battery is discharging increasing the Psys_LIMIT until charger charge rate is equal to a minimum charge rate, wherein the charger charge rate represents the rate at which the battery is charging the charger.

20. The SOC of claim 16, wherein the power controller is further configured to evaluate a battery relative state of charge (RSOC) by the power controller on the SOC and based at least in part on determining that the RSOC is below and that a total power Psys delivered to the SOC is above a minimum PSU power P_PSU_MIN, reducing the Psys_LIMIT.
